(19) United States
(12) Patent Application Publication
(10) Pub. No.: US 2023/0072312 A1
(43) Pub. Date: Mar. 9, 2023

(54) SYSTEM AND METHOD TO ADD AN ADDITIONAL DRIVE AXLE TO A VEHICLE

(71) Applicant: Joseph Ghattas, Fort Laurderdale, FL (US)

(72) Inventor: Joseph Ghattas, Fort Laurderdale, FL (US)

(21) Appl. No.: 17/882,743

(22) Filed: Aug. 8, 2022

Related U.S. Application Data
(60) Provisional application No. 63/241,761, filed on Sep. 8, 2021.

(51) Int. Cl. F16H 57/025; F16H 57/021; F16H 57/037

(52) U.S. Cl. CPC F16H 57/025; F16H 57/021; F16H 57/037; F16H 2057/0075

(57) ABSTRACT

A system and method to add an additional drive axle to a vehicle may include an auxiliary shaft aperture bored through the differential housing and an auxiliary shaft sleeve mounted over the aperture. An auxiliary shaft has a splined end interconnected to a modified pinion and a short transfer drive shaft interconnect disposed on an opposite end thereof, the short transfer drive shaft interconnect extending out from the modified differential housing through the auxiliary shaft sleeve. A short transfer drive shaft is operatively interconnected to the auxiliary shaft and rotational therewith. Further, an additional drive axle assembly is mounted to the vehicle rearward of the original drive axle, and the modified differential is operatively interconnected to an additional drive axle via the short transfer drive shaft, such that when the short transfer drive shaft rotates with the auxiliary shaft, the additional drive axle rotates with the original drive axle.

### CROSS-REFERENCE TO RELATED APPLICATION

This application claims the benefit of U.S. Provisional Patent Application Ser. No. 63/241,761 filed on Sep. 8, 2021, which is incorporated by reference herein in its entirety.

### FIELD OF THE INVENTION

The present invention relates generally to modifying an original differential by installing an auxiliary shaft, and interconnecting an additional drive axle to the modified differential via a short transfer drive shaft.

### BACKGROUND OF THE INVENTION WHOLE

Typical stock passenger vehicles are shipped from the factory with two axles one in front and one in the rear, each having two wheels attached at opposite ends. A majority of passenger vehicles are 2-wheel drive vehicles, which may be either a front wheel drive, i.e., having a front differential installed on the front axle, or a rear wheel drive, wherein a rear differential is installed on a rear axle. The differential, among other things, serves to control the energy from the engine through the transmission out to each wheel of the axle, as well as to control the speed of each wheel, which becomes critical while cornering a vehicle.

Passenger vehicles also include 4-wheel drive models, wherein both the front axle and the rear axle include a differential to provide power to all four wheels. While originally installed primarily on sport type vehicles, such as Jeeps, more and more passenger cars are being manufactured with 4-wheel drive capacity to provide improved handling, especially in inclement weather and/or over challenging terrain.

A 4-wheel drive vehicle also includes a transfer case to essentially distribute power to each of the front and rear differentials. As will be appreciated, the transfer case and each of the front and rear differentials must be in proper working order to maximize the performance of a 4-wheel drive vehicle.

Just as there are operational advantages of a 4-wheel drive vehicle over a 2-wheel drive vehicle, there are a number of operational advantages to having an additional drive axle on a vehicle, wherein the additional drive axle is typically installed in the rear. These advantages include, but are not limited to, increasing towing capacity, loading capacity and traction.

Unfortunately, present methods for retrofitting a vehicle to add an additional (or more) drive axle to a stock passenger vehicle is expensive and complicated, and requires extensive additional equipment including, but not limited to, a full additional drive shaft, an additional transfer case, and associated linkages.

Accordingly, there is an established need for a resolution for one or more of the issues currently faced when retrofitting a vehicle to add an additional drive axle. This is the case because current solutions fall short on providing adequate travel (articulation), speed, noise reduction and wear out faster due to overcomplicated moving parts.

### SUMMARY OF THE INVENTION

As before, the present invention relates generally to a system and a method to add an additional drive axle to a vehicle which includes modifying an original differential by installing an auxiliary shaft, and interconnecting the additional drive axle to the modified differential via a short transfer drive shaft.

In a first implementation of the invention, a system to add an additional drive axle to a vehicle may comprise: an auxiliary shaft aperture bored through the original differential housing; an auxiliary shaft sleeve mounted over the auxiliary shaft aperture; an auxiliary shaft having a splined end dimensioned and configured to interconnect to a modified pinion; the auxiliary shaft having a short transfer drive shaft interconnect disposed on an opposite end thereof, the short transfer drive shaft interconnect extending rearwardly out from the modified differential housing through the auxiliary shaft sleeve; a short transfer drive shaft operatively interconnected to the auxiliary shaft and rotational therewith; and an additional drive axle assembly mounted to the vehicle rearward of the original drive axle, the modified differential operatively interconnected to an additional drive axle via the short transfer drive shaft, the short transfer drive shaft rotates with the auxiliary shaft thereby causing the additional drive axle to rotate with the original drive axle.

In a second aspect, the system to add an additional drive axle to a vehicle can include an auxiliary shaft bearing mounted in the auxiliary shaft sleeve, thereby forming a modified differential housing.

In another aspect, the system to add an additional drive axle to a vehicle may have an auxiliary shaft bearing dimensioned to receive a portion of the auxiliary shaft therethrough to facilitate rotation of the auxiliary shaft when the modified pinion is rotated by the original drive shaft.

In a further aspect, the system to add an additional drive axle to a vehicle can include an auxiliary shaft bearing comprises a ring bearing.

In one other aspect, the system to add an additional drive axle to a vehicle may have a modified pinion including a plurality of pinion splines cooperatively dimensioned and configured with the splined end of the auxiliary shaft to securely receive the splined end of the auxiliary shaft therein.

In yet another aspect, the system to add an additional drive axle to a vehicle can include an auxiliary shaft having a flange mounted to the short transfer drive shaft interconnect.

In still one further aspect, the system to add an additional drive axle to a vehicle may have an auxiliary shaft further including a U-joint interconnected thereto, the short transfer drive shaft having a modified differential interconnect on one end which operatively engages the U-joint, such that the short transfer drive shaft rotates with the auxiliary shaft.

In yet one other aspect, the system to add an additional drive axle to a vehicle can include a short transfer drive shaft having an additional drive axle interconnect on an opposite end thereof which operatively engages and rotates the additional drive axle while the auxiliary shaft rotates.

In still another aspect, the system to add an additional drive axle to a vehicle may have an additional drive axle assembly including a plurality of additional drive axle tires.

In another implementation of the invention, a system to add an additional drive axle to a vehicle may comprise: an auxiliary shaft aperture bored through the original differential housing; an auxiliary shaft sleeve mounted over the auxiliary shaft aperture, the auxiliary shaft sleeve having an auxiliary shaft bearing mounted therein, thereby forming a modified differential housing; an auxiliary shaft having a splined end configured to interconnect to a modified pinion, the modified pinion comprising a plurality of pinion splines cooperatively dimensioned and configured with the splined end of the auxiliary shaft to securely receive the splined end of the auxiliary shaft therein; the auxiliary shaft having a short transfer drive shaft interconnect disposed on an opposite end thereof, the short transfer drive shaft interconnect extending rearwardly out from the modified differential housing through the auxiliary shaft sleeve; a short transfer drive shaft operatively interconnected to the auxiliary shaft and rotational therewith; and an additional drive axle mounted to the vehicle rearward of the original drive axle, the modified differential operatively interconnected to the additional drive axle via the short transfer drive shaft, the short transfer drive shaft rotates with the auxiliary shaft thereby causing the additional drive axle to rotate with the original drive axle.

In yet one further aspect, the system to add an additional drive axle to a vehicle can include an auxiliary shaft sleeve mounted external of the modified differential housing.

In still one other aspect, the system to add an additional drive axle to a vehicle may have a U-joint mounted to the flange mounted to the short transfer drive shaft interconnect.

In a further implementation of the invention, a method to add an additional drive axle to a vehicle may comprise: dissembling an original differential of the vehicle to expose the original differential housing; boring an auxiliary shaft aperture through the original differential housing; mounting an auxiliary shaft sleeve over the auxiliary shaft aperture; milling and splining the original pinion thereby forming a modified pinion; connecting a splined end of an auxiliary shaft to the modified pinion such that the auxiliary shaft rotates with the modified pinion; reassembling the modified differential with a portion of the auxiliary shaft extending outwardly from the rear of the modified differential housing through the auxiliary shaft sleeve; mounting a flange to the portion of the auxiliary shaft extending outwardly from the modified differential; mounting a U-joint to the flange mounted to the portion of the auxiliary shaft extending outwardly from the modified differential; installing an additional drive axle assembly to the vehicle; and interconnecting an additional drive axle of the additional drive axle assembly to the modified differential via a short transfer drive shaft, wherein the short transfer drive shaft rotates with the auxiliary shaft thereby causing the additional drive axle to rotate with the original drive axle.

In still one further aspect, the method to add an additional drive axle to a vehicle may include milling and splining the original pinion further comprising forming a plurality of pinion splines cooperatively dimensioned and configured with the splined end of the auxiliary shaft to securely receive the splined end of the auxiliary shaft therein.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a top perspective view of an original differential housing opened to permit access thereinto, in accordance with the present invention.

FIG. 2 presents a top perspective view of one illustrative embodiment of a modified differential housing having an auxiliary shaft aperture bored through the back thereof, in accordance with the present invention;

FIG. 3 presents a rear perspective view of the modified differential housing of FIG. 2 having an auxiliary shaft bearing sleeve mounted over the auxiliary shaft aperture, in accordance with the present invention;

FIG. 4 presents a perspective view of one illustrative embodiment of an auxiliary shaft, in accordance with the present invention.

FIG. 5 presents a perspective view of one illustrative embodiment of an auxiliary shaft installed in a modified differential, in accordance with the present invention;

FIG. 6 presents a cutaway plan view of one illustrative embodiment of an auxiliary shaft interconnected to a modified pinion in a modified differential, in accordance with the present invention;

FIG. 7 presents an exploded perspective view of one illustrative embodiment of a modified differential having an auxiliary shaft installed therein, in accordance with the present invention;

FIG. 8 presents a perspective view of the modified differential of FIG. 7 having an auxiliary shaft installed therein and extending outwardly therefrom through a bearing sleeve, in accordance with the present invention;

FIG. 9 presents a bottom plan view of one illustrative embodiment of a modified differential mounted to a vehicle and interconnected to an additional axle via a short transfer drive shaft, in accordance with the present invention; and

FIG. 10 presents a diagrammatic representation of one illustrative embodiment of a method to add an additional drive axle to a vehicle, in accordance with the present invention.

### DETAILED DESCRIPTION

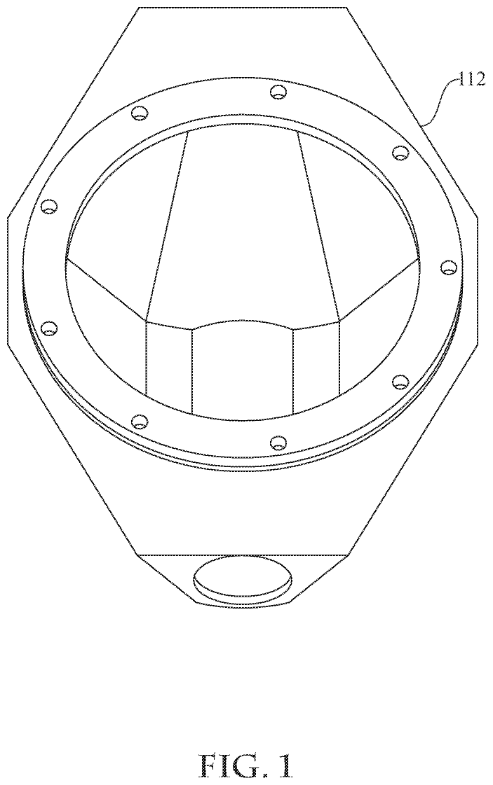

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”. “left”, “rear”, “right”. “front”. “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

As noted above, the present invention includes a system, generally as shown as at 100 throughout the figures, and a method, generally as shown as at 1000 throughout the figures, to retrofit a vehicle to add an additional drive axle 152 which is operative with an original drive axle of the vehicle. The present system 100 and method 1000 include forming a modified differential 120 from an original differential by installing an auxiliary shaft 130 in the modified differential 120 which is operative with a short transfer drive shaft 140 operatively interconnecting the modified differential 120 to the additional drive axle assembly 150 without the need for an additional transfer case or the additional linkages associated therewith. A significant benefit of the present system 100 and method 1000 is that the modified differential 120 can be installed on any and all vehicles, including those with a solid axle, by simply providing custom bracketry and ends as are known and needed to effect vehicle retrofits.

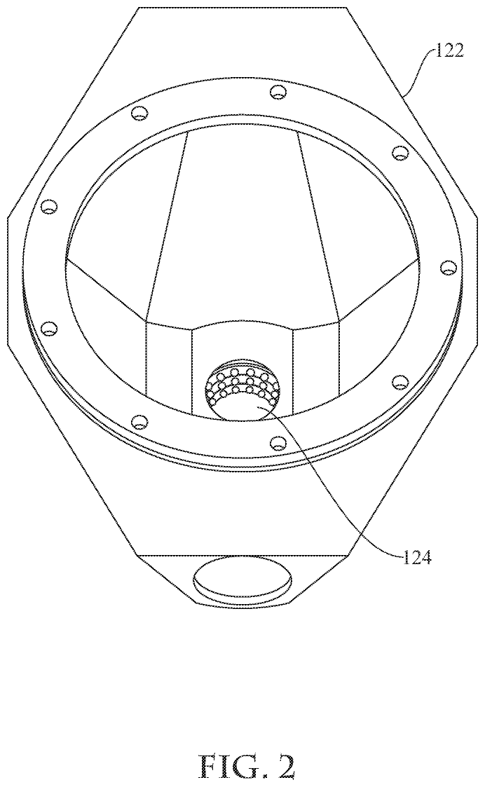

Turning now to the figures, and beginning with FIG. 1, presented therein is a top perspective view of an original differential housing 112 which has been opened, and the original differential components including but not limited to an original pinon and an original ring gear 113 have been removed to permit access thereinto. Looking next to FIG. 2, an auxiliary shaft aperture 124 is bored through a back wall of the original differential housing 112, such as is shown by way of example in FIG. 1, thereby forming a modified differential housing 122.

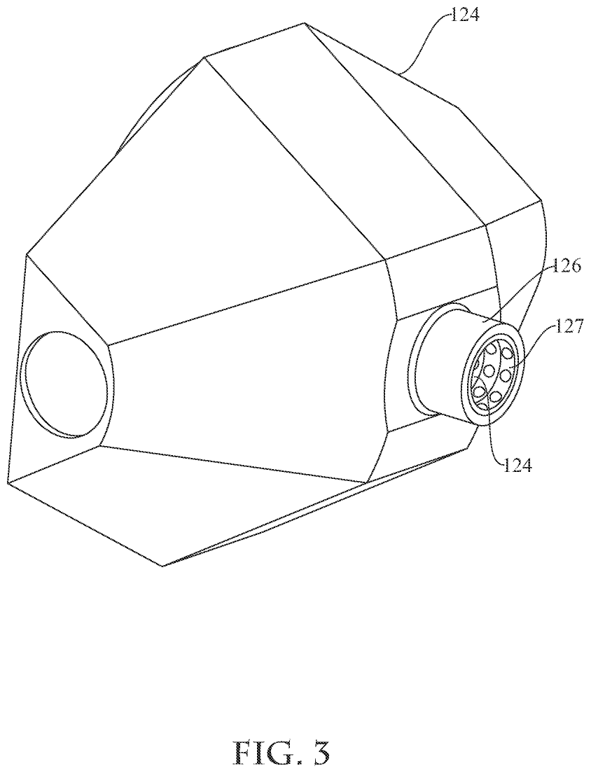

Looking next to FIG. 3, a rear perspective view of the modified differential housing 122 of FIG. 2 having an auxiliary shaft bearing sleeve 126 mounted over an auxiliary shaft aperture 124 in accordance with at least one embodiment of the present invention is shown. In at least one embodiment, an auxiliary shaft bearing 127 is mounted in an auxiliary shaft sleeve 126, such as is shown by way of example in FIGS. 2 and 3. In one further embodiment, an auxiliary shaft bearing 127 is dimensioned to receive a portion of an auxiliary shaft 130 therethrough to facilitate rotation of the auxiliary shaft 130 when a modified pinion 128 is rotated by an original drive shaft 116, as is described in greater detail hereinafter. An auxiliary shaft bearing 127 in at least one embodiment comprises a ring bearing. In at least one further embodiment, an auxiliary shaft bearing 127 comprises a sealed double row angular contact bearing.

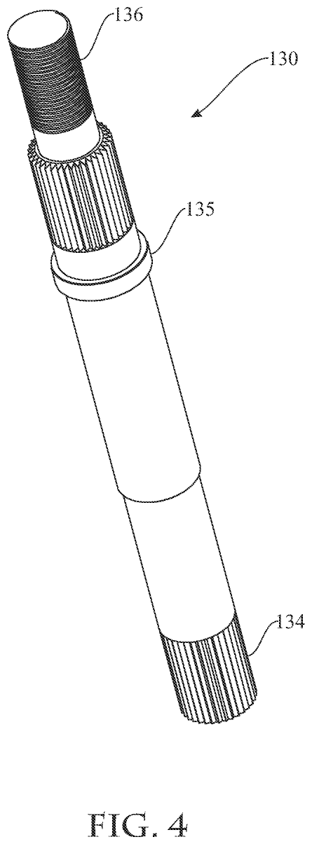

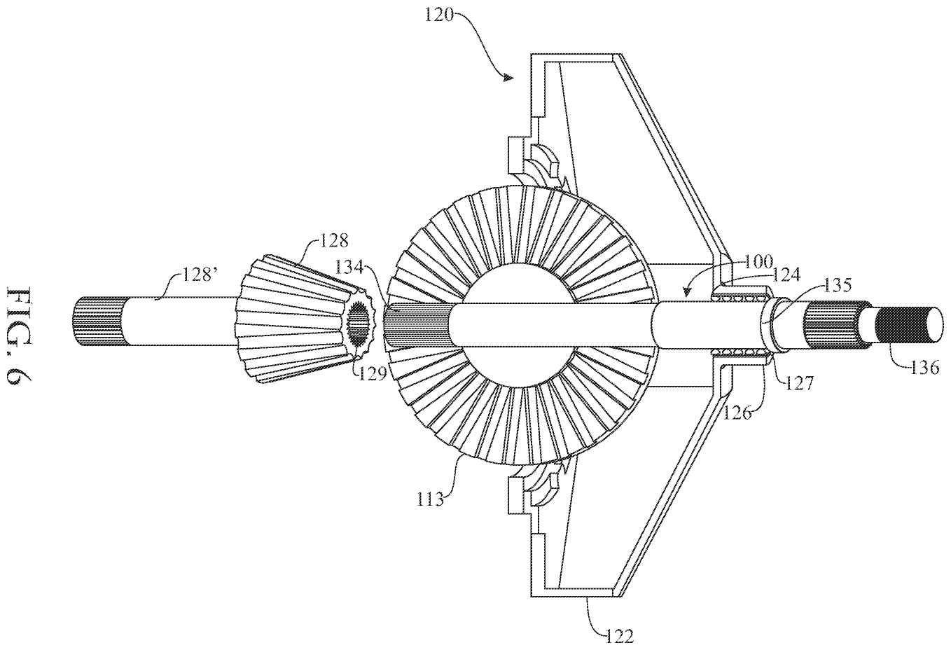

As stated above, the present system to add an additional drive axle to a vehicle 100 includes modifying an original differential by installing an auxiliary shaft 130. An auxiliary shaft 130 in at least one embodiment of the present invention includes an elongated configuration having oppositely disposed ends. With reference to the illustrative embodiment of FIG. 4, an auxiliary shaft 130 comprises an elongated cylindrical configuration. As may be seen from FIG. 4, the auxiliary shaft 130 includes a splined end 134 and an oppositely disposed short transfer driveshaft interconnect 136. The splined end 134 of the auxiliary shaft 130 is dimensioned and configured to be received and secured in modified pinion splines 129 of a modified pinion 128, such as is shown by way of example in FIG. 6.

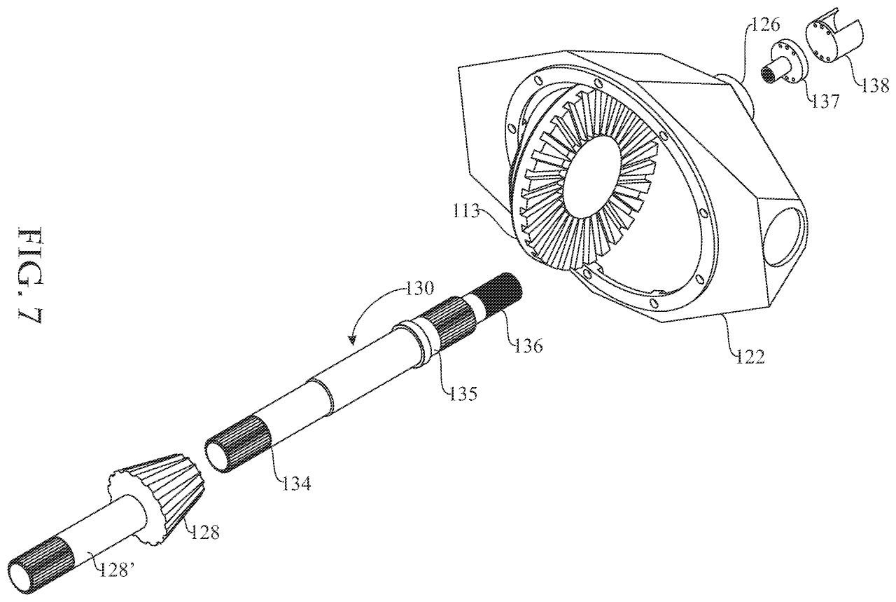

More in particular, the present system to add an additional drive axle to a vehicle 100 includes milling an original pinion from an original differential to form a channel dimensioned to receive the splined end 134 of the auxiliary shaft 130 therein. The present system 100 also includes splining the channel formed in the original pinion such that the splined end 134 of the auxiliary shaft 130 and the modified pinion splines 129 of the modified pinion 128 are cooperatively configured and dimensioned such that that the splined end 134 of the auxiliary shaft 130 is received and securely retained by the modified pinion splines 129, thereby securing the auxiliary shaft 130 and the modified pinion 128 to one another. As will be appreciated, additional mechanical fastening mechanisms may be utilized to assure that the auxiliary shaft 130 and the modified pinion 128 remain securely attached to one another during operation. As one example, one or more setscrews may be utilized to further secure the modified pinion 128 to the auxiliary shaft 130. As another example, the modified pinion 128 may be further secured to the auxiliary shaft 130 by way of adhesives, welds, etc., just to name a few. As may be seen best in FIGS. 6 and 7, in at least one embodiment, a modified pinion 128 further comprises a modified pinion shaft 128′ secured to one end thereof. The modified pinion shaft 128′ is provided to facilitate interconnection to the original drive shaft 116, such as, by way of example, via an original flange and U-joint.

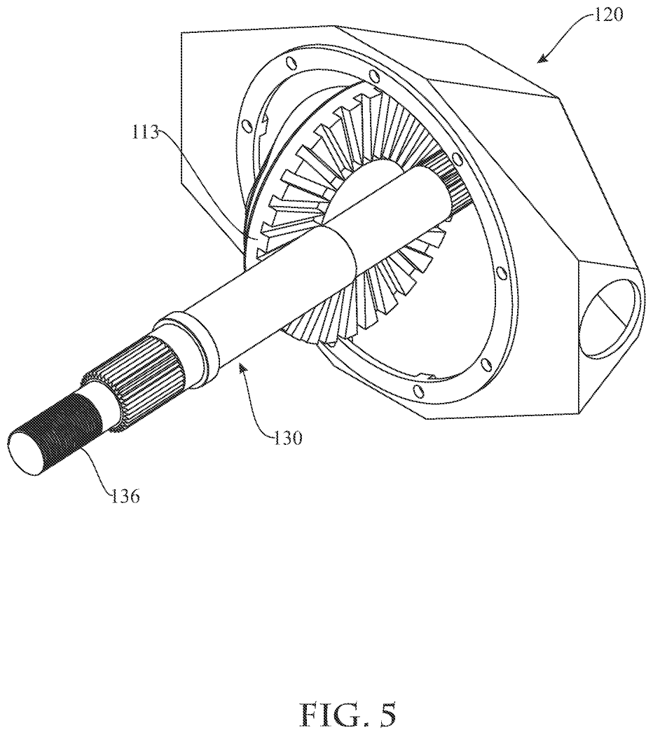

FIG. 5 presents a perspective view of one illustrative embodiment of an auxiliary shaft 130 installed in a modified differential 120, in accordance with at least one embodiment of the present invention. Looking further to FIG. 6, an auxiliary shaft 130 is installed through an auxiliary shaft bearing 127 mounted in an auxiliary shaft sleeve 126, with the splined end 134 of the auxiliary shaft 130 extending inwardly into the modified differential 120. As further shown in FIG. 6, a shaft stop 135 is provided on the auxiliary shaft 130 in at least one embodiment to assure that the splined end 134 of the auxiliary shaft is properly positioned relative to the original ring gear 113, such that when the modified pinion 128 is securely attached to the splined end 134 of the auxiliary shaft 130, the modified pinion 128 is disposed in the proper position to operatively engage and rotate the ring gear 130, when the modified pinon is rotated by the original drive shaft 116.

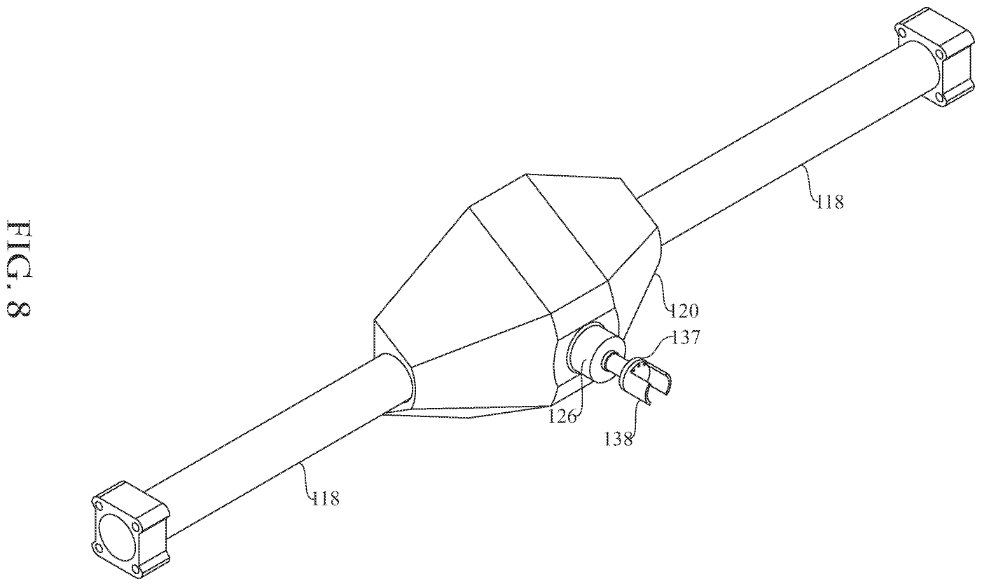

With continued reference to FIG. 6, the major internal components of a modified differential 120, such as, by way of example only, a modified Ford 9″ 3rd member differential, in accordance with the present system 100 are presented. As may be seen, an original pinion has been milled and splined so as to receive a splined end 134 of an auxiliary shaft 130 therein. The modified pinion 128 is reinstalled in the modified differential 120 in a driving relation to the original ring gear 113. As will be appreciated, as the modified pinion 128 is driven by the original drive shaft 116 of the vehicle 110, which subsequently turns the original ring gear 113 and the original drive axle 118 itself, the auxiliary shaft 130 will also rotate. As further shown in FIG. 6, a short transfer driveshaft interconnect 136 of the auxiliary shaft 130 extends outwardly from the modified differential housing 122 through the auxiliary shaft bearing 127 mounted in the auxiliary shaft sleeve 126, as described hereinabove. A short transfer driveshaft interconnect 136, in at least one embodiment, comprises a threaded configuration to facilitate securely mounting a flange 137 thereon. As shown in FIG. 6, in at least one further embodiment, the short transfer driveshaft interconnect 136 comprises both threaded and splined connections to allow flexibility in mounting a flange 137 thereon. Looking further to FIGS. 7 and 8, the flange 137 is attached to the short transfer driveshaft interconnect 136, external of the modified differential housing 122, and a U-joint 138 is secured to the flange 137 to facilitate operative interconnection of a short transfer drive shaft 140 thereto, such as is described in greater detail hereinafter.

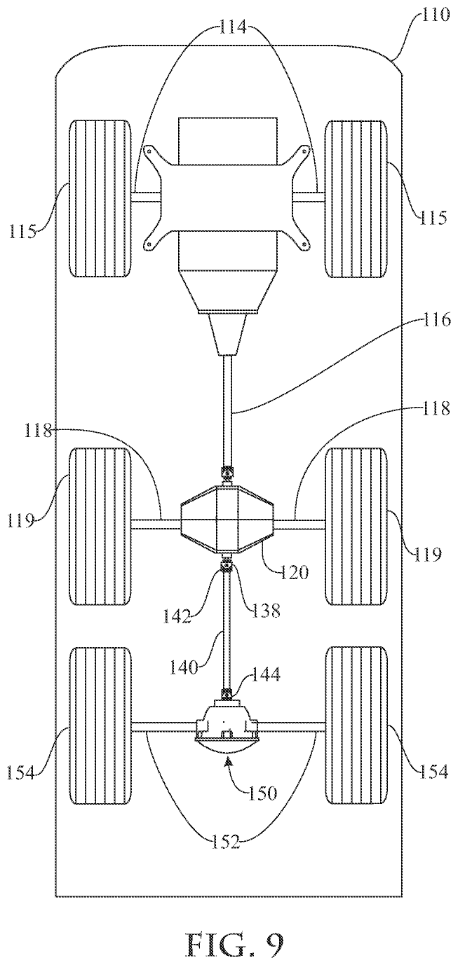

As will be appreciated, an auxiliary shaft 130 in at least one embodiment is utilized to drive a short transfer drive shaft 140, which in turn is interconnected to drive an additional drive axle assembly 150, such as is shown by way of example in FIG. 9. More in particular, as the vehicle 110 accelerates, the original drive shaft 116, which is operatively interconnected to a modified differential 120, causes a modified pinon 128 therein to rotate, as described above, thereby also causing the auxiliary shaft 130 to rotate. The modified pinion 128 also engages and rotates an original ring gear 113 thereby causing the original drive axle 118, and the corresponding original rear tires 119, to rotate, thus propelling the vehicle 110 forward or rearward. As shown in FIG. 9, an original front axle 114 and original front tires 115 are essentially free spinning and rotate in the direction corresponding the rotation of the original drive axle 118.

With continued reference to FIG. 9, a short transfer drive shaft 140 includes a modified differential interconnect 142 on one end to operatively interconnect with the U-joint 138 of the auxiliary shaft (not shown) of the modified differential 120, such that the short transfer drive shaft 140 rotates with the auxiliary shaft 130. The short transfer drive shaft 140 also includes an additional axle interconnect 144 disposed on an opposite end thereof to operatively engage the additional drive axle assembly 150 thereby causing the additional drive axle 152 and the additional tires 119 to rotate with the original drive axle 118. As will be further appreciated, the present system 100 eliminates the need for a full additional drive shaft to drive the additional drive axle assembly 150, and further, the present system 100 eliminates the need for an additional transfer case to distribute power to the additional drive axle 152, thereby eliminating the need for all of the additional linkages associated therewith.

As previously disclosed, the present invention is also directed to a method to add an additional drive axle assembly to a vehicle 1000, wherein the additional drive axle assembly is operative with an original drive axle of the vehicle. More in particular, the present invention includes a method to add an additional drive axle to a vehicle 1000, wherein the vehicle includes an original differential mounted to an original drive axle, the original differential having an original pinion engaging an original ring gear within an original differential housing, and the original differential is operatively interconnected to an original drive shaft which rotates the pinion causing the original ring gear to rotate, which in turn rotates the original drive axle.

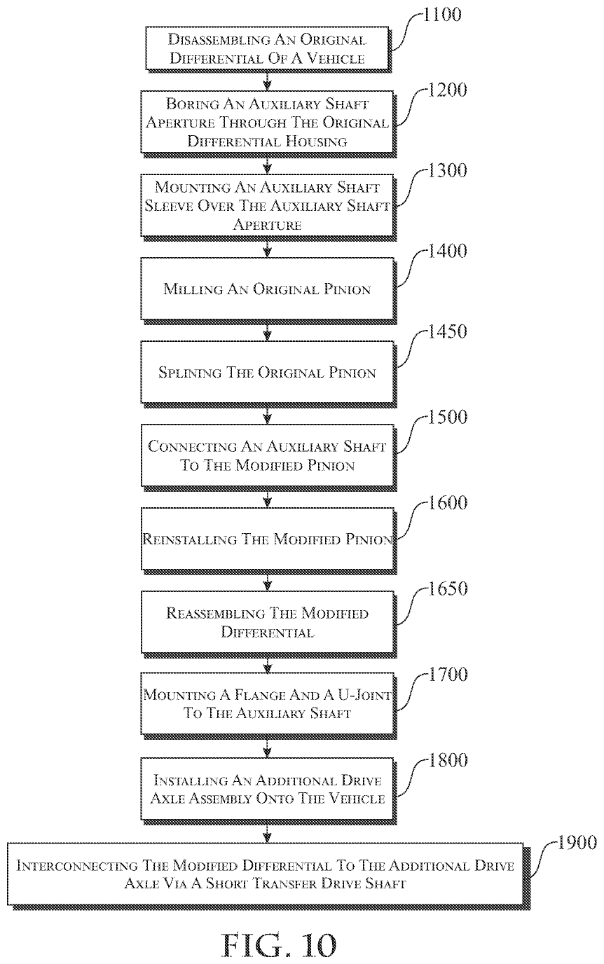

With reference to FIG. 10, in at least one embodiment, the present method 1000 includes dissembling an original differential of a vehicle 1100 to expose the original differential housing. Further, the present method 1000 requires boring an auxiliary shaft aperture through the original differential housing 1200. With continued reference to FIG. 10, the present method to add an additional drive axle assembly 1000 includes mounting an auxiliary shaft sleeve over the auxiliary shaft aperture 1300, thereby forming a modified differential housing, such as is shown best in FIG. 3, as described hereinabove.

In at least one embodiment, the present method to add an additional drive axle to a vehicle 1000 further comprises milling an original pinion 1400 to form a channel therein dimensioned to receive one end of an auxiliary shaft therein. The present method 1000 also includes splining the original pinion 1450 to form modified pinion splines in the channel milled into the original pinion, thereby forming a modified pinion. As before, the modified pinion splines are cooperatively configured and dimensioned such that that the splined end of an auxiliary shaft is received and securely retained by the modified pinion splines of the modified pinion, thereby securing the auxiliary shaft and the modified pinion to one another.

With continued reference to FIG. 10, the present method 1000 includes connecting a splined end of an auxiliary shaft to the modified pinion 1500 such that the auxiliary shaft rotates with the modified pinion. Further, the present method to add an additional drive axle to a vehicle 1000 includes reinstalling the modified pinion 1600 in the modified differential. As before, in at least one embodiment, a shaft stop is provided on the auxiliary shaft to assure that the splined end of the auxiliary shaft is properly positioned relative to an original ring gear such that when the modified pinion is securely attached to the splined end of the auxiliary shaft, the modified pinion is disposed in a proper position to operatively engage and rotate the ring gear when the modified pinon is rotated by the original drive shaft.

The present method 1000 also includes reassembling the modified differential 1650 with a portion of the auxiliary shaft extending outwardly from the rear of the modified differential housing through the auxiliary shaft sleeve. The method 1000 further comprises mounting a flange to the portion of the auxiliary shaft extending outwardly from the modified differential 1700, and mounting a U-joint to the flange mounted to the portion of the auxiliary shaft extending outwardly from the modified differential. Finally, the present method to add an additional drive axle to a vehicle 1000 comprises installing an additional drive axle assembly onto the vehicle 1800, and interconnecting an additional drive axle of the additional drive axle assembly to the modified differential via the short transfer drive shaft 1900. As such, when the short transfer drive shaft rotates with the auxiliary shaft, the additional drive axle rotates with the original drive axle. As before, a significant benefit of the present method to add an additional drive axle to a vehicle 1000 is that the modified differential can be installed on any and all vehicles by simply providing custom bracketry and ends as are known and needed to effect vehicle retrofits.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

What is claimed is:

1. A system to add an additional drive axle to a vehicle having an original differential mounted to an original drive axle, the original differential having an original pinion engaging an original ring gear within an original differential housing, the original differential operatively interconnected to an original drive shaft which rotates the pinion causing the original ring gear to rotate, which in turn rotates the original drive axle, said system comprising:
an auxiliary shaft aperture bored through the original differential housing;
an auxiliary shaft sleeve mounted over said auxiliary shaft aperture;
an auxiliary shaft having a splined end dimensioned and configured to interconnect to a modified pinion;
said auxiliary shaft having a short transfer drive shaft interconnect disposed on an opposite end thereof, said short transfer drive shaft interconnect extending rearwardly out from said modified differential housing through said auxiliary shaft sleeve;
a short transfer drive shaft operatively interconnected to said auxiliary shaft and rotational therewith; and
an additional drive axle assembly mounted to the vehicle rearward of the original drive axle, said modified differential operatively interconnected to an additional drive axle via said short transfer drive shaft, said short transfer drive shaft rotates with said auxiliary shaft thereby causing said additional drive axle to rotate with the original drive axle.

2. The system as recited in claim 1, further comprising an auxiliary shaft bearing mounted in said auxiliary shaft sleeve, thereby forming a modified differential housing.

3. The system as recited in claim 2, wherein said auxiliary shaft bearing is dimensioned to receive a portion of said auxiliary shaft therethrough to facilitate rotation of said auxiliary shaft when said modified pinion is rotated by the original drive shaft.

4. The system as recited in claim 2, wherein said auxiliary shaft bearing comprises a ring bearing.

5. The system as recited in claim 1, wherein said modified pinion comprises a plurality of pinion splines cooperatively dimensioned and configured with said splined end of said auxiliary shaft to securely receive said splined end of said auxiliary shaft therein.

6. The system as recited in claim 1, wherein said auxiliary shaft comprises a flange mounted to said short transfer drive shaft interconnect.

7. The system as recited in claim 6, wherein said auxiliary shaft further comprises a U-joint interconnected thereto, said short transfer drive shaft having a modified differential interconnect on one end which operatively engages said U-joint, such that said short transfer drive shaft rotates with said auxiliary shaft.

8. The system as recited in claim 7, wherein said short transfer drive shaft comprises an additional drive axle interconnect on an opposite end thereof which operatively engages and rotates said additional drive axle while said auxiliary shaft rotates.

9. The system as recited in claim 1, wherein said additional drive axle assembly further comprises a plurality of additional drive axle tires.

10. A system to add an additional drive axle to a vehicle having an original differential mounted to an original drive axle, the original differential having an original pinion engaging an original ring gear within an original differential housing, the original differential operatively interconnected to an original drive shaft which rotates the pinion causing the original ring gear to rotate, which in turn rotates the original drive axle:
an auxiliary shaft aperture bored through the original differential housing;
an auxiliary shaft sleeve mounted over said auxiliary shaft aperture, said auxiliary shaft sleeve having an auxiliary shaft bearing mounted therein, thereby forming a modified differential housing;
an auxiliary shaft having a splined end configured to interconnect to a modified pinion, said modified pinion comprising a plurality of pinion splines cooperatively dimensioned and configured with said splined end of said auxiliary shaft to securely receive said splined end of said auxiliary shaft therein;
said auxiliary shaft having a short transfer drive shaft interconnect disposed on an opposite end thereof, said short transfer drive shaft interconnect extending rearwardly out from said modified differential housing through said auxiliary shaft sleeve;
a short transfer drive shaft operatively interconnected to said auxiliary shaft and rotational therewith; and
an additional drive axle mounted to the vehicle rearward of the original drive axle, said modified differential operatively interconnected to said additional drive axle via said short transfer drive shaft, said short transfer drive shaft rotates with said auxiliary shaft thereby causing said additional drive axle to rotate with the original drive axle.

11. The system as recited in claim 10, wherein said auxiliary shaft sleeve is mounted external of said modified differential housing.

12. The system as recited in claim 10, wherein said auxiliary shaft bearing is dimensioned to receive a portion of said auxiliary shaft therethrough to facilitate rotation of said auxiliary shaft when said modified pinion is rotated by the original drive shaft.

13. The system as recited in claim 10, wherein said auxiliary shaft bearing comprises a ring bearing.

14. The system as recited in claim 10, wherein said auxiliary shaft comprises a flange mounted to said short transfer drive shaft interconnect.

15. The system as recited in claim 14, wherein said auxiliary shaft further comprises a U-joint interconnected thereto, said short transfer drive shaft having a modified differential interconnect on one end which operatively engages said U-joint, such that said short transfer drive shaft rotates with said auxiliary shaft.

16. The system as recited in claim 15, wherein said short transfer drive shaft comprises an additional drive axle interconnect on an opposite end thereof which operatively engages and rotates said additional drive axle while said auxiliary shaft rotates.

17. The system as recited in claim 15, wherein said U-joint is mounted to said flange mounted to said short transfer drive shaft interconnect.

18. A method to add an additional drive axle to a vehicle having an original differential mounted to an original drive axle, the original differential having an original pinion engaging an original ring gear within an original differential housing, the original differential operatively interconnected to an original drive shaft which rotates the pinion causing the original ring gear to rotate, which in turn rotates the original drive axle, the method comprising:
dissembling an original differential of the vehicle to expose the original differential housing;
boring an auxiliary shaft aperture through the original differential housing;
mounting an auxiliary shaft sleeve over the auxiliary shaft aperture;
milling and splining the original pinion thereby forming a modified pinion;
connecting a splined end of an auxiliary shaft to the modified pinion such that the auxiliary shaft rotates with the modified pinion;
reassembling the modified differential with a portion of the auxiliary shaft extending outwardly from the rear of the modified differential housing through the auxiliary shaft sleeve;
mounting a flange to the portion of the auxiliary shaft extending outwardly from the modified differential;
mounting a U-joint to the flange mounted to the portion of the auxiliary shaft extending outwardly from the modified differential;
installing an additional drive axle assembly to the vehicle; and
interconnecting an additional drive axle of the additional drive axle assembly to the modified differential via a short transfer drive shaft, wherein the short transfer drive shaft rotates with the auxiliary shaft thereby causing the additional drive axle to rotate with the original drive axle.

19. The method as recited in claim 18, further comprising mounting an auxiliary shaft bearing in the auxiliary shaft sleeve, wherein the auxiliary shaft bearing is dimensioned to receive a portion of the auxiliary shaft therethrough to facilitate rotation of the auxiliary shaft when the modified pinion is rotated by the original drive shaft.

20. The method as recited in claim 18, wherein milling and splining the original pinion further comprises forming a plurality of pinion splines cooperatively dimensioned and configured with the splined end of the auxiliary shaft to securely receive the splined end of the auxiliary shaft therein.
